(19) United States
(12) Patent Application Publication
(10) Pub. No.: US 2018/0305978 A1
(43) Pub. Date: Oct. 25, 2018

(54) MODULAR MOTORIZED WINDOW COVERING

(71) Applicant: TTI (MACAO COMMERCIAL OFFSHORE) LIMITED, Macau (MO)

(72) Inventors: J. Porter Whitmire, Greenville, SC (US); Mark Huggins, Anderson, SC (US); Tanvi Singh, Pune (IN); J. Luke Jenkins, Anderson, SC (US)

(21) Appl. No.: 15/956,569

(22) Filed: Apr. 18, 2018

Related U.S. Application Data
(60) Provisional application No. 62/487,369, filed on Apr. 19, 2017.

(51) Int. Cl. E06B 9/70; E06B 9/266

(52) U.S. Cl. CPC E06B 9/70; E06B 9/266

(57) ABSTRACT

A window covering assembly includes a roller to which a window cover is attached and a motorized assembly. The motorized assembly imparts a force via a power transmission system to the roller, thereby causing the roller to rotate and the window covering to raise or lower. The roller and motorized assembly are modular and are not permanently joined to each other.

This application claims the benefit of U.S. Provisional Application No. 62/487,369, filed Apr. 19, 2017, the contents of which are hereby incorporated by reference in their entirety.

### SUMMARY OF THE INVENTION

The present invention relates to a window covering assembly, and more particularly, to such an assembly that includes a motor-powered mechanism that is separate from the covering. In one embodiment, the motor-powered mechanism raises and lowers the covering by way of a gear assembly connecting the motor-powered mechanism and the covering. Because the components of the assembly are modular, a user is able to replace one of the components while retaining the other.

### BRIEF DESCRIPTION OF THE DRAWINGS

FIG. 1 is an exploded view of a window covering assembly according to one exemplary embodiment of the present invention.

FIG. 2 is a side view of a window covering assembly according to one exemplary embodiment of the present invention.

FIG. 3 is a perspective view of a window covering assembly according to one exemplary embodiment of the present invention.

### DETAILED DESCRIPTION OF THE PREFERRED EMBODIMENT

Reference will now be made in detail to the preferred embodiment of the present invention, which is illustrated in the accompanying drawing.

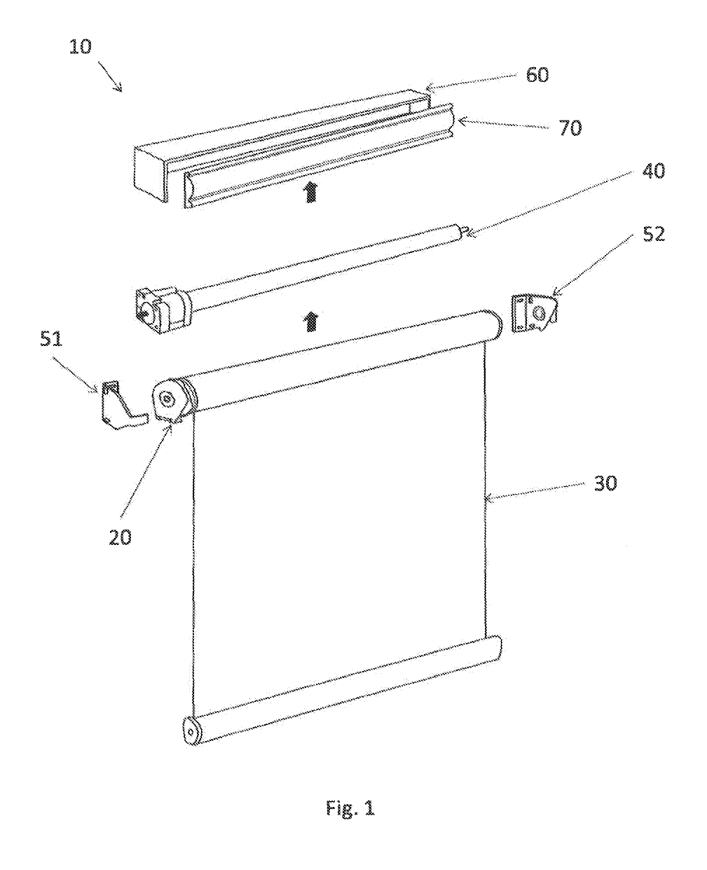

FIGS. 1-3 show a window covering assembly according to one embodiment of the present invention. As shown in FIG. 1, the window covering assembly 10 may include a roller 20, around which a window cover 30 is wound. Upon rotation of the roller 20, window cover 30 is either raised or lowered, depending on the direction of rotation of roller 20. In one embodiment, window cover 30 is a screen; however, other window coverings may be used. For example, cellular blinds, as are commonly known in the art, may be used. In case of cellular blinds, the blinds are not wound around roller 20. Rather, a string that is attached to the bottom of the blinds is wound around a spool. Upon rotation of the spool, the bottom of the string is either raised or lowered, depending on the direction of rotation of the spool. This, in turn, either raises or lowers the cellular blinds.

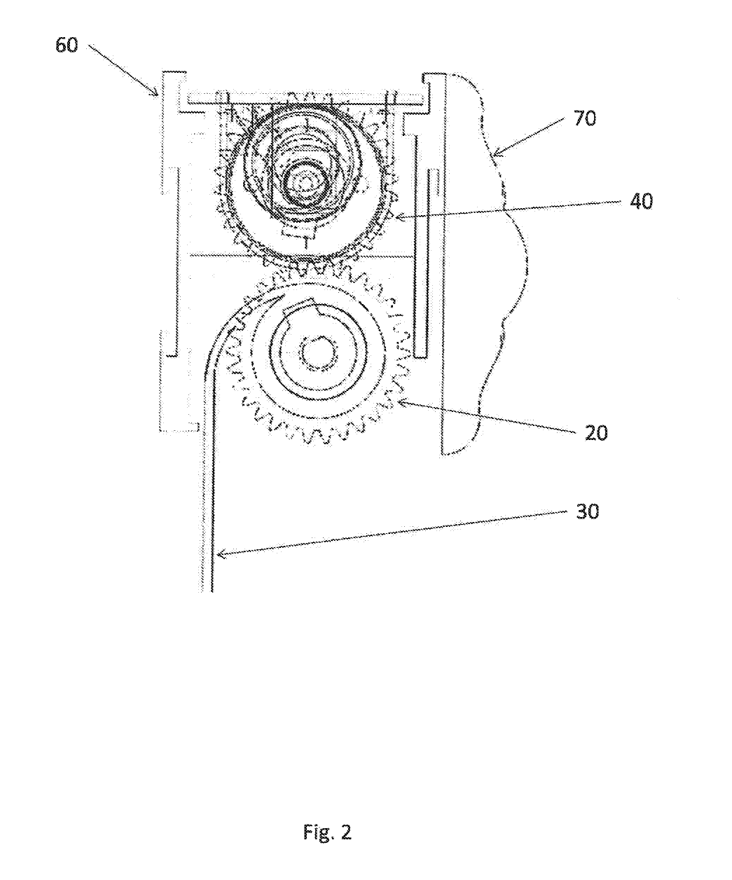

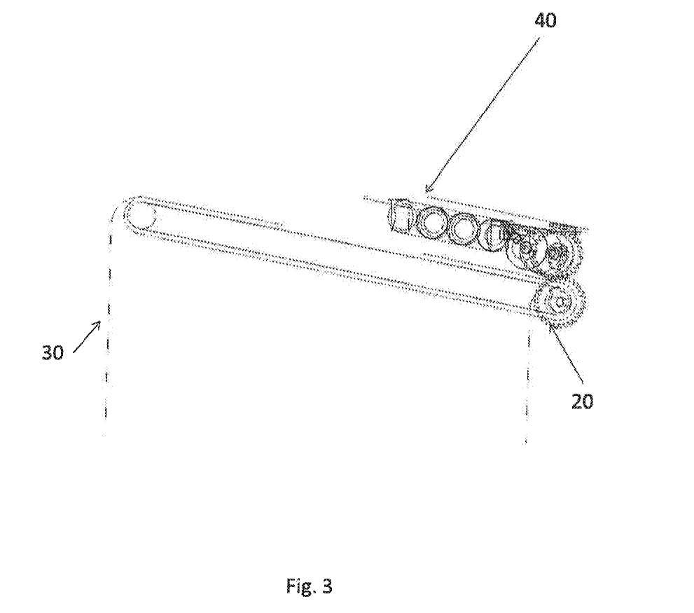

As is also shown in FIG. 1, the window covering assembly 10 may include a motor assembly 40. In one embodiment, this assembly includes a motor which, when activated, causes a shaft to rotate. As shown in FIGS. 2 and 3, this shaft may be connected to a spur gear that interfaces with a matching spur gear on the roller 20. In this way, the roller 20 is caused to rotate and thereby raise or lower the window cover 30. The present invention is not limited to the power transmission system just described. Other gearing mechanisms may be used, and other power transmission systems, including chain drives and belt drives, may be used.

As is also shown in FIG. 1, the window covering assembly 10 may include mounting brackets 51, 52. In one embodiment, these mounting brackets secure the roller 20 and motor assembly 40 to a window frame. A roller channel 60 and valance 70 may be placed over the roller 20 and motor assembly 40 when the window covering assembly 10 is installed in a window frame. This visually obscures the roller 20 and motor assembly 40, increasing the aesthetic appearance of the window covering assembly 10.

In one embodiment of the present invention, the roller 20 and motor assembly 40 are modular and are not permanently joined to each other. This is shown in FIGS. 1-3. This modular aspect of the present invention allows for flexibility in creating a window covering assembly 10. A user may match a motor assembly 40 that has the desired technical specifications with a roller 20 and covering 30 that have the desired design. Moreover, the modular aspect of the present invention also allows for flexibility in replacement of parts. For example, a user may replace a motor assembly 40 while keeping the roller 20 with the covering 30. This may be desired by a user when the motor assembly 40 is defective, but the user does not wish to replace the roller 20 with the covering 30. As another example, a user desiring to change the design of the window covering assembly 10 may replace only roller 20 with covering 30, and retain motor assembly 40.

It will be apparent to those skilled in the art that various modifications and variations can be made in the modular motorized window blinds assembly of the present invention without departing from the spirit or scope of the invention. Thus, it is intended that the present invention cover modifications and variations of this invention provided they come within the scope of the appended claims and their equivalents.

What is claimed is:

1. A window covering assembly comprising:
a roller;
a motor assembly; and
a window cover, wherein
the window cover is attached to the roller,
the window cover is raised when the roller rotates in a first angular direction,
the window cover is lowered when the roller rotates in a second angular direction, opposite the first angular direction,
the motor assembly interfaces with the roller via a power transmission system, and
the roller and motor assembly are not permanently joined to each other.

2. The window covering assembly according to claim 1, further comprising mounting brackets.

3. The window covering assembly according to claim 2, further comprising a roller channel and a valance.

4. The window covering assembly according to claim 1, wherein the power transmission system comprises spur gears.
